(19) United States
(12) Patent Application Publication
(10) Pub. No.: US 2022/0049632 A1
(43) Pub. Date: Feb. 17, 2022

(54) Camshaft adjusting system and method for operating a camshaft adjusting system

(71) Applicant: Schaeffler Technologies AG & Co. KG, Herzogenaurach (DE)

(72) Inventors: Marcel Mannweiler, Nürnberg (DE); Jochen Auchter, Gerhardshofen (DE)

(73) Assignee: Schaeffler Technologies AG & Co. KG, Herzogenaurach (DE)

(21) Appl. No.: 17/429,034

(22) PCT Filed: Nov. 13, 2019
(86) PCT No.: PCT/DE2019/100977

§ 371 Date: Aug. 6, 2021

(30) Foreign Application Priority Data
Feb. 8, 2019 (DE) 10 2019 103 104.4

(51) Int. Cl. F01L 1/344; H02K 7/14

(52) U.S. Cl. CPC F01L 1/344; F01L 2001/34496; H02K 7/14

(57) ABSTRACT

A camshaft adjusting system includes a first electromechanical camshaft adjuster, which is configured for the adjustment of an intake camshaft, and a second electromechanical camshaft adjuster, which is configured for the adjustment of an exhaust camshaft. At least one of the camshaft adjusters can be operated as a generator and is linked to an energy store for the supply of energy to the other camshaft adjuster.

### CROSS-REFERENCE TO RELATED APPLICATIONS

This application is the U.S. National Phase of PCT Application No. PCT/DE2019/100977 filed on Nov. 13, 2019, which claims priority to DE 10 2019 103 104.4 filed on Feb. 8, 2019, the entire disclosure of which is incorporated by reference herein.

### TECHNICAL FIELD

This disclosure relates to a camshaft adjusting system, which comprises a camshaft adjuster provided for adjusting an intake camshaft and a camshaft adjuster provided for adjusting an exhaust camshaft. The disclosure further relates to a method for operating such a camshaft adjusting system.

### BACKGROUND

A camshaft adjusting system with which both the intake camshaft of an internal combustion engine and the exhaust camshaft of the internal combustion engine can be adjusted is described, for example, in DE 10 2015 208 456 A1.

Electromechanical camshaft adjusters work, for example, with a harmonic gearbox as the actuating transmission. In this context, reference is made to the documents DE 10 2016 221 802 A1, DE 10 2014 213 130 B4 and DE 10 2016 220 918 A1 by way of example.

A further camshaft adjuster with electric drive is disclosed in DE 103 52 361 A1. The electric adjusting motor of this camshaft adjuster has a permanent magnet rotor which, if the adjusting motor fails, can be braked by an electric brake designed as a brake winding in order to reach and hold a base position of the camshaft.

### SUMMARY

The object of the disclosure is to further develop a camshaft adjusting system for adjusting the intake and exhaust camshafts of an internal combustion engine compared to the prior art mentioned, in particular from an energetic point of view.

According to the disclosure, this object is achieved by a camshaft adjusting system having the features described herein. The object is also achieved by a method for operating a camshaft adjusting system installed in a reciprocating engine. The embodiments and advantages of the disclosure explained below in connection with the operating method also apply analogously to the device, i.e. the camshaft adjusting system, and vice versa.

The camshaft adjusting system comprises a first electromechanical camshaft adjuster which is configured for the adjustment of an intake camshaft and a second electromechanical camshaft adjuster which is configured for the adjustment of an exhaust camshaft, wherein at least one of the camshaft adjusters can be operated as a generator and is linked to an energy store, which is provided for the supply of energy to the other camshaft adjuster.

The disclosure is based on the consideration that different loads occur on the intake camshaft and on the exhaust camshaft of an internal combustion engine, to which loads an adjuster provided for adjusting the relevant shaft is to be matched. The intake camshaft is primarily loaded by the kinematic torque and the frictional torque of the valve train of the internal combustion engine, i.e. the reciprocating engine. In the case of the exhaust camshaft, significant loads from gas forces in the cylinder also occur. In addition, there may be torques that are generated by a high-pressure pump.

Overall, only a low torque is typically applied to the intake camshaft, whereas a significantly greater torque is applied to the exhaust camshaft, which is also significantly influenced by the load on the internal combustion engine.

It is also assumed that three-shaft transmissions, which are suitable for use as actuating transmissions in an electromechanical camshaft adjuster, can in principle be designed either as positive gearboxes or as negative gearboxes.

In both cases, a mechanically driven element, typically driven via a chain or belt drive, which can also be designed as a housing or housing part of the actuating transmission, acts as the input-side shaft of the three-shaft transmission. The output-side shaft of the three-shaft transmission is firmly connected to the shaft to be adjusted, i.e. the camshaft. The third shaft of the three-shaft transmission is electrically driven in the case of an electromechanical camshaft adjuster. If this third shaft rotates at the same speed as the input-side shaft, i.e. typically the chain or belt wheel, then the output-side shaft also rotates at this speed. This applies to both positive gearboxes and negative gearboxes. A design as a positive gearbox means that an adjustment of the electrically driven shaft in relation to the input-side shaft in a first direction leads to an adjustment of the output-side shaft with respect to the input-side shaft in the same direction. In contrast, in the case of a negative gearbox, an adjustment of the electrically driven shaft relative to the input-side shaft in a first direction is converted into an opposite adjustment between the output-side shaft or the input-side shaft.

When the camshaft to be adjusted is braked, in the case of a negative gearbox, an accelerating torque is introduced into the shaft that is electrically driven in other operating phases, i.e. the motor shaft of the electric motor. The “other operating phases” are to be understood as operating states in which the camshaft is actively adjusted, i.e. by energizing the electric motor.

According to the disclosure, the accelerating torque is useful for using the otherwise electrically driven shaft of the actuating gear of the camshaft adjuster as the input shaft of the electric motor of the camshaft adjuster, which in this case is operated as a generator.

At least one electric motor of the two camshaft adjusters can thus be used either as a motor or as a generator, the latter case meaning that the electric motor acts as a brake. This creates the possibility of operating the electric drive of a camshaft adjuster as a generator in a first operating phase of the camshaft adjusting system. Energy gained during this first operating phase is stored. The stored energy is used in a later operating phase to actuate the other camshaft adjuster. There can also be an overlap of the operating phases mentioned.

In an example embodiment of the camshaft adjusting system, the actuating transmission of the camshaft adjuster provided for actuating the intake camshaft is designed as a positive gearbox. In contrast, the actuating transmission that is assigned to the camshaft adjuster provided for actuating the exhaust camshaft can be a negative gearbox.

In an example embodiment, both camshaft adjusters are assigned a common power electronics unit which, in the case of operation with three-phase alternating voltage, comprises a B6 bridge for controlling the respective electric motor. In this case, the energy store is connected between the two B6 bridges. For example, the energy store comprises a capacitor. Electrochemical storage of energy is also possible.

The camshaft adjusting system enables, in particular, the storage of energy that is obtained when the exhaust camshaft is adjusted. This energy can be used at a later point in time to adjust the intake camshaft. If sufficient energy is stored, it can also be used to adjust the exhaust camshaft.

### BRIEF DESCRIPTION OF THE DRAWINGS

In the following, an exemplary embodiment of the disclosure is explained in more detail by means of a drawing. In the figures:

FIG. 1 shows a camshaft adjusting system in a schematic representation.

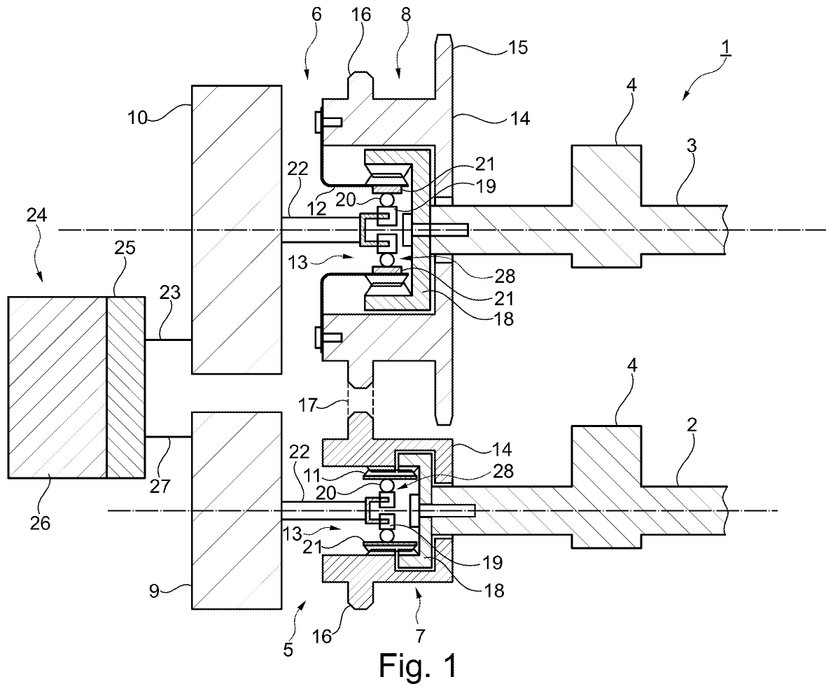

### DETAILED DESCRIPTION

A camshaft adjusting system, identified overall with the reference number 1, enables the adjustment of an intake camshaft 3 and an exhaust camshaft 2 of an internal combustion engine of a motor vehicle, which is not shown further. Cams of the camshafts 2, 3 are denoted by 4. A first camshaft adjuster 6 is provided for adjusting the intake camshaft 3. A second camshaft adjuster 5 is used to adjust the exhaust camshaft 2. Both camshaft adjusters 5, 6 are electromechanical camshaft adjusters.

Both camshaft adjusters 5, 6 are constructed in a basic concept known per se from an actuating transmission 7, 8 and an electric motor 9, 10 provided for its actuation. The actuating transmission 7, 8 in both cases is a three-shaft transmission in the form of a harmonic gearbox. The actuating transmission 8 of the first, i.e. the intake-side, camshaft adjuster 6 is designed as a positive gearbox. The actuating transmission 7 of the second camshaft adjuster 5, on the other hand, is constructed as a negative gearbox.

In accordance with the principle, each actuating transmission 7, 8 works with an elastic gear element 11, 12. In the illustrated exemplary embodiment, the elastic gear element 11 of the actuating transmission 7 is a flex ring. The elastic gear element 12 of the actuating transmission 8, on the other hand, is designed as a collar sleeve. In both cases, a wave generator 13 is provided for deforming the elastic gear element 11, 12. The wave generator 13 is inserted into a drive element 14, designed as a housing, of the actuating transmission 7, 8. The drive elements 14 are mechanically driven and each represent a first shaft of the respective actuating transmission 7, 8.

In the exemplary embodiment, the actuating transmission 8 has a first sprocket 15 as part of the drive element 14. The first sprocket 15 is driven in a manner known per se via the crankshaft of the internal combustion engine, rotating at half the crankshaft speed. The drive element 14 of the actuating transmission 7 is also mechanically driven via a second sprocket 16 present on the same drive element 14. For this purpose, the drive element 14 of the actuating transmission 7 also has a sprocket 16. A chain mechanically coupling the actuating transmissions 7, 8 to one another is denoted by 17 and only indicated by dashed lines.

The elastic gear element 11, 12 of each actuating transmission 7, 8 interacts directly with an output element 18, which in both cases is designed as a ring gear and is firmly connected to the camshaft 2, 3 to be adjusted. The output element 18, i.e. the output ring gear, represents the second shaft of the actuating transmission 7, 8.

In both cases, an inner ring 19 of a roller bearing 28, which is assigned to the wave generator 13, functions as the third shaft. The inner ring 19 has an elliptical, non-circular outer circumferential surface on which balls 20 roll as rolling elements. The associated outer ring of the roller bearing 28 is denoted by 21. In contrast to the inner ring 19, the outer ring 21 is elastically resilient so that it permanently adapts to the non-round shape of the inner ring 19. The outer ring 21 is directly surrounded by the externally toothed elastic gear element 11, 12.

In the case of the second, i.e. exhaust-side, camshaft adjuster 5, the external toothing of the elastic gear element 11 engages both an internal toothing of the drive element 14 and an internal toothing of the output element 18. The number of teeth of the external toothing of the elastic gear element 11, i.e. flex ring, corresponds to the number of teeth of the internal toothing of the output element 18. The flex ring 11, together with the output element 18, thus forms a coupling stage of the actuating transmission 7. The number of teeth of the internal toothing of the drive element 14, on the other hand, is slightly, namely, two times, greater than the number of teeth of the external toothing of the flex ring 11. This means that the transmission stage of this actuating transmission 7 is formed between the flex ring 11 and the drive element 14 of the actuating transmission 7. If the inner ring 19 is rotated in a certain direction with respect to the drive element 14 of the actuating transmission 7, the output element 18 of the actuating transmission 7 rotates in the opposite direction with respect to the drive element 14 by a much smaller angle. This means that the actuating transmission 7 is designed as a negative gearbox. A braking of the exhaust camshaft 2 is implemented accordingly to an acceleration of the inner ring 19.

In the case of the actuating transmission 8, which is located on the inlet side, the external toothing of the elastic gear element 12, which in this case is designed as a collar sleeve, interacts exclusively with the internal toothing of the output element 18. In this case, the number of teeth of the elastic gear element 12 is two less than the number of teeth of the internal toothing of the output element 18. This has the result that a rotation of the inner ring 19 with respect to the drive element 14 in a first setting direction is converted into a pivoting in the same direction between the intake camshaft 3 and the drive element 14. This means that the actuating transmission 8 is designed as a positive gearbox.

The inner ring 19 of each wave generator is coupled non-rotatably to an electric motor shaft 22. In the case of the exhaust-side camshaft adjuster 5, the torque introduced into the electric motor shaft 22 via the actuating transmission 7 when braking the exhaust camshaft 2 is used to operate the electric motor 9 of the camshaft adjuster 5 as a generator. For this purpose, the electric motor 9 is connected via a line 27 to a control device designated as a whole by 24. The control device 24 comprises a power electronics unit 25 and an energy store 26. In the exemplary embodiment, the energy store 26 comprises a supercapacitor. Such a capacitor is characterized by the ability to absorb and release energy very quickly.

In the present case, the energy diverted from the energy store 26 is used to supply the first electromechanical camshaft adjuster 6, which is connected to the control device 24 via a line 23, with electrical energy. The power electronics unit 25 comprises two B6 bridges (not shown), which each work with six MOSFETs and control an electric motor 9, 10. The energy store 26 is connected between the two B6 bridges. The energy store 26 is optionally supplemented by an electrochemical store, i.e. an accumulator.

### LIST OF REFERENCE SYMBOLS

1 Camshaft adjusting system
2 Exhaust camshaft
3 Intake camshaft
4 Cam
5 Camshaft adjuster of the exhaust camshaft
6 Camshaft adjuster of the intake camshaft
7 Actuating transmission as a negative gearbox
8 Actuating transmission as a positive gearbox
9 Electric motor
10 Electric motor
11 Elastic gear element, flex ring
12 Elastic gear element, collar sleeve
13 Wave generator
14 Drive element
15 Sprocket
16 Sprocket
17 Chain
18 Output element
19 Inner ring
20 Rolling element, ball
21 Outer ring
22 Electric motor shaft
23 Line
24 Control device
25 Power electronics unit
26 Energy store
27 Line
28 Roller bearing

1. A camshaft adjusting system, comprising:
a first electromechanical camshaft adjuster configured for adjustment of an intake camshaft, and
a second electromechanical camshaft adjuster configured for adjustment of an exhaust camshaft, and
at least one of the camshaft adjusters is configured to operate as a generator and is electrically connected to an energy store configured to supply energy to a remaining one of the camshaft adjusters.

2. The camshaft adjusting system of claim 1, wherein each of the first and second camshaft adjusters comprises:
a three-shaft transmission configured as an actuating transmission, and
an electric motor configured for actuation of the three-shaft transmission.

3. The camshaft adjusting system of claim 2, wherein the three-shaft transmission is a harmonic gearbox.

4. The camshaft adjusting system of claim 2, wherein the actuating transmission of the first electromechanical camshaft adjuster is configured as a positive gearbox.

5. The camshaft adjusting system of claim 4, wherein the actuating transmission of the second electromechanical camshaft adjuster is configured as a negative gearbox.

6. The camshaft adjusting system of claim 1, wherein the energy store comprises a capacitor.

7. A method for operating a camshaft adjusting system of an internal combustion engine, the method comprising:
providing a camshaft adjusting system having two camshaft adjusters, each camshaft adjuster having an electric motor,
operating the electrical motor of one of the two camshaft adjusters as a generator in a first operating phase so that energy is gained by the camshaft adjusting system, and
storing the energy gained during the first operating phase, and
using the stored energy for actuating a remaining one of the two camshaft adjusters.

8. The method of claim 7, wherein energy gained during adjustment of an exhaust camshaft is stored and used for adjusting an intake camshaft.

9. The method of claim 7, wherein the camshaft adjusting system includes a first camshaft adjuster for an intake camshaft and a second camshaft adjuster for an exhaust camshaft.

10. The method of claim 9, wherein each of the first and second camshaft adjusters are electromechanical camshaft adjusters.

11. The method of claim 9, wherein a first actuating transmission of a first one of the two camshaft adjusters is configured as a positive gearbox, and a second actuating transmission of a second one of the two camshaft adjusters is configured as a negative gearbox.

12. The method of claim 9, wherein the exhaust camshaft operates as a generator in the first operating phase.

13. The method of claim 12, wherein an actuating transmission of the exhaust camshaft is configured as a negative gearbox.

14. A camshaft adjusting system for an internal combustion engine, the camshaft adjusting system comprising:
a first camshaft adjuster configured for adjustment of a first camshaft, and
a second camshaft adjuster configured for adjustment of a second camshaft, and
at least one of the camshaft adjusters is configured to operate as a generator and is electrically connected to an energy store configured to supply electrical energy to a remaining one of the camshaft adjusters.

15. The camshaft adjusting system of claim 14, wherein the first camshaft adjuster includes a first harmonic gearbox and the second camshaft adjuster includes a second harmonic gearbox.

16. The camshaft adjusting system of claim 15, wherein the first harmonic gearbox is configured as a positive gearbox, and the second harmonic gearbox is configured as a negative gearbox.

17. The camshaft adjusting system of claim 15, further comprising a controller electrically connected to both the first camshaft adjuster and the second camshaft adjuster, the controller including the energy store and a power electronics unit.

18. The camshaft adjusting system of claim 17, wherein the energy store is configured to receive electrical energy from the second camshaft adjuster and deliver at least a portion of the electrical energy to at least one of the first camshaft adjuster or the second camshaft adjuster.

19. The camshaft adjusting system of claim 18, wherein the first camshaft adjuster includes a first electric motor, and the second camshaft adjuster includes a second electric motor, and the first and second electric motors are electrically connected to the controller.

20. The camshaft adjusting system of claim 19, wherein the first camshaft adjuster is mechanically coupled to the second camshaft adjuster.
